(19) United States
(12) Patent Application Publication
(10) Pub. No.: US 2006/0248969 A1
(43) Pub. Date: Nov. 9, 2006

(54) One-way rotational transfer mechanism

(75) Inventors: Shuzo Seo, Saitama (JP); Takuji Hamasaki, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/405,425

(22) Filed: Apr. 18, 2006

(30) Foreign Application Priority Data
Apr. 21, 2005 (JP) 2005-123952

(51) Int. Cl. F16H 37/16

(52) U.S. Cl. 74/20

(57) ABSTRACT

A one-way rotational transfer mechanism includes a rotary input shaft and a hollow-cylindrical rotary output shaft coaxially arranged; a bearing supporting the rotary input shaft and the hollow-cylindrical rotary output shaft and on which a first orthogonal surface is formed; a circumferentially-uneven-width-space forming portion formed on the rotary input shaft to form an accommodation space; a retainer which moves with the rotary input shaft and on which a second orthogonal surface is formed; and a roller member installed in the accommodation space and held between the first and second orthogonal surfaces. The circumferentially-uneven-width-space forming portion is shaped so that rotation of the rotary input shaft is transferred to the hollow-cylindrical rotary output shaft via the roller member. The bearing, the retainer and the roller member are made of a magnetic material, and magnetic circuits attract the roller member to the first and second orthogonal surfaces.

### BACKGROUND OF THE INVENTION

1. Field of the Invention

The present invention relates to a one-way rotational transfer mechanism having a rotary input shaft and a rotary output shaft which are concentrically arranged, wherein rotation of the rotary input shaft is transferred to the rotary output shaft when the rotary input shaft is rotated, but rotation of the rotary output shaft is not transferred to the rotary input shaft when the rotary output shaft is rotated.

2. Description of the Related Art

A one-way rotational transfer mechanism having a rotary input shaft and a rotary output shaft which are concentrically arranged, wherein rotation of the rotary input shaft is transferred to the rotary output shaft when the rotary input shaft is rotated by, e.g., motor, and wherein the motor is prevented from being rotated by rotation of the rotary output shaft (i.e., prevents the rotary input shaft from being rotated by rotation of the rotary output shaft) when the rotary output shaft is rotated, has been proposed by the assignee of the present invention in Japanese unexamined patent publication No. 2004-69054. Note that the term “one-way rotational transfer” used in the present specification and claims refers to the rotation of the rotary input shaft being allowed to be transferred to the rotary output shaft while preventing rotation of the rotary output shaft from being transferred to the rotary input shaft.

The one-way rotational transfer mechanism disclosed in the above-mentioned patent publication includes: a rotary input shaft movable in the axial direction thereof; a hollow-cylindrical rotary output shaft in which the rotary input shaft is inserted and is supported to be freely rotatable relative to the rotary input shaft; a first orthogonal surface formed on a bearing member to lie in a plane orthogonal to the axis of the rotary input shaft, wherein the bearing member supports the rotary input shaft and the hollow-cylindrical rotary output shaft in a manner to allow these two shafts to be freely rotatable; at least one circumferentially-uneven-width-space forming portion formed on the rotary input shaft to form at least one circumferentially-uneven-width space between the circumferentially-uneven-width-space forming portion and a cylindrical surface on an inner peripheral surface of the hollow-cylindrical rotary output shaft, wherein the circumferentially-uneven-width space has different radial widths at different circumferential positions; at least one roller member installed in the circumferentially-uneven-width space; a retainer which is provided integrally with the rotary input shaft and has a second orthogonal surface lying in a plane orthogonal to the axis of the rotary input shaft to hold the roller member between the retainer and the first orthogonal surface; and a spring device which biases the retainer in a direction toward the first orthogonal surface. The circumferentially-uneven-width-space forming portion is shaped so as to transfer a rotary motion to the hollow-cylindrical rotary output shaft via the roller member, to which a rotary motion is given by the first and second orthogonal surfaces upon the rotary input shaft being rotated.

However, in this one-way rotational transfer mechanism that is disclosed in Japanese unexamined patent publication No. 2004-69054, the efficiency of transmitting a torque from the rotary input shaft to the hollow-cylindrical rotary output shaft is not satisfactory because friction produced between the spring device and the retainer when the rotary input shaft and the retainer integrally rotate together is a factor which reduces a torque transferred from the rotary input shaft to the hollow-cylindrical rotary output shaft.

### SUMMARY OF THE INVENTION

The present invention provides a one-way rotational transfer mechanism which allows rotation of the rotary input shaft to be transferred to the rotary output shaft while preventing rotation of the rotary output shaft from being transferred to the rotary input shaft, wherein an improvement in efficiency of transmitting a torque from the rotary input shaft to the rotary output shaft is achieved.

According to an aspect of the present invention, a one-way rotational transfer mechanism is provided, including a rotary input shaft and a hollow-cylindrical rotary output shaft which are coaxially arranged about a common axis, the rotary input shaft being movable along the common axis and being rotatable about the common axis; a bearing which supports the rotary input shaft and the hollow-cylindrical rotary output shaft and on which a first orthogonal surface is formed to lie in a plane orthogonal to the axis; a circumferentially-uneven-width-space forming portion integrally formed on the rotary input shaft to form at least one accommodation space between the circumferentially-uneven-width-space forming portion and a cylindrical inner peripheral surface of the hollow-cylindrical rotary output shaft, the accommodation space having different radial widths at different circumferential positions about the axis; a retainer which moves with the rotary input shaft and on which a second orthogonal surface is formed to face the first orthogonal surface and is parallel to the first orthogonal surface; and at least one roller member installed in the accommodation space and held between the first orthogonal surface and the second orthogonal surface, each of the bearing, the retainer and the roller member being made of a magnetic material; and at least one magnetic circuit which creates a magnetic attractive force attracting the first orthogonal surface and the roller member to each other, and attracting the roller member and the second orthogonal surface to each other. The circumferentially-uneven-width-space forming portion is shaped so that a rotation of the rotary input shaft is transferred to the hollow-cylindrical rotary output shaft via the roller member to which the rotation is applied via the first orthogonal surface and the second orthogonal surface when the rotary input shaft is rotated.

It is desirable for the roller member to be a ball made of the magnetic material.

It is desirable for the roller member to include a ball made of the magnetic material; and a hollow cylinder made of a non-magnetic material in which the ball is loosely fitted. An axial length of the hollow cylinder is smaller than a diameter of the ball. The hollow cylinder is positioned in associated the accommodation space so that an axis of the hollow cylinder extends substantially parallel to each of an axis of the rotary input shaft and an axis of the hollow-cylindrical rotary output shaft.

It is desirable for the roller member to be a cylindrical column roller which is positioned in the associated accommodation space so that an axis of the cylindrical column roller extends substantially in a radial direction of the rotary input shaft.

It is desirable for the circumferentially-uneven-width-space forming portion to include a non-circular cross section portion which includes at least one surface orthogonal to a radial direction of the rotary input shaft.

It is desirable for the circumferentially-uneven-width-space forming portion having the non-circular cross section to be in the shape of a polygon.

It is desirable for the circumferentially-uneven-width-space forming portion to include a non-circular cross section portion which has at least one pair of inclined surfaces which are symmetrical with respect to a line extending in a radial direction of the rotary input shaft.

It is desirable for the circumferentially-uneven-width-space forming portion to include an eccentric cylindrical surface which is eccentric from the axis of the rotary input shaft.

It is desirable for the magnetic circuit to be formed with magnets positioned between the first orthogonal surface and the second orthogonal surface.

It is desirable for the magnet to be a permanent magnet.

In another embodiment, a one-way rotational transfer mechanism is provided, including a hollow-cylindrical rotary input shaft and a rotary output shaft which are coaxially arranged about a common axis, the hollow-cylindrical rotary input shaft being movable along the common axis and being rotatable about the common axis; a bearing which supports the hollow-cylindrical rotary input shaft and the rotary output shaft and on which a first orthogonal surface is formed to lie in a plane orthogonal to the axis; a circumferentially-uneven-width-space forming portion integrally formed on an inner peripheral surface of the hollow-cylindrical rotary input shaft to form at least one accommodation space between the circumferentially-uneven-width-space forming portion and a cylindrical outer peripheral surface of the rotary output shaft, the accommodation space having different radial widths at different circumferential positions about the axis; a retainer which moves with the hollow-cylindrical rotary input shaft and on which a second orthogonal surface is formed to face the first orthogonal surface and is parallel to the first orthogonal surface; and at least one roller member installed in the accommodation space and held between the first orthogonal surface and the second orthogonal surface, each of the bearing, the retainer and the roller member being made of a magnetic material; and at least one magnetic circuit which creates a magnetic attractive force attracting the first orthogonal surface and the roller member to each other, and attracting the roller member and the second orthogonal surface to attract each other. The circumferentially-uneven-width-space forming portion is shaped so that a rotation of the hollow-cylindrical rotary input shaft is transferred to the rotary output shaft via the roller member to which the rotation is applied via the first orthogonal surface and the second orthogonal surface when the hollow-cylindrical rotary input shaft is rotated.

The roller member can be a ball made of the magnetic material.

It is desirable for the roller member to include a ball made of the magnetic material, and a hollow cylinder made of a non-magnetic material in which the ball is loosely fitted. An axial length of the hollow cylinder is smaller than a diameter of the ball. The hollow cylinder is positioned in associated the accommodation space so that an axis of the hollow cylinder extends substantially parallel to each of an axis of the hollow-cylindrical rotary input shaft and an axis of the rotary output shaft.

It is desirable for the roller member to include a cylindrical column roller which is positioned in associated the accommodation space so that an axis of the cylindrical column roller extends substantially in a radial direction of the rotary input shaft.

It is desirable for the circumferentially-uneven-width-space forming portion to include a non-circular cross section portion which includes at least one surface orthogonal to a radial direction of the hollow-cylindrical rotary input shaft.

It is desirable for the circumferentially-uneven-width-space forming portion having the non-circular cross section to be in the shape of a polygon.

It is desirable for the circumferentially-uneven-width-space forming portion to include a non-circular cross section portion which has at least one pair of inclined surfaces which are symmetrical with respect to a line extending in a radial direction of the hollow-cylindrical rotary input shaft.

It is desirable for the circumferentially-uneven-width-space forming portion to include an eccentric cylindrical surface which is eccentric from the axis of the hollow-cylindrical rotary input shaft.

It is desirable for the magnetic circuit to be formed with magnets positioned between the first orthogonal surface and the second orthogonal surface. The magnet can be a permanent magnet.

According to the present invention, the efficiency of transmitting a torque from the rotary input shaft to the rotary output shaft is improved.

The present disclosure relates to subject matter contained in Japanese Patent Application No. 2005-123952 (filed on Apr. 21, 2005) which is expressly incorporated herein by reference in its entirety.

### BRIEF DESCRIPTION OF THE DRAWINGS

The present invention will be described below in detail with reference to the accompanying drawings in which:

FIG. 1 is a longitudinal cross sectional view of a first embodiment of a one-way rotational transfer mechanism according to the present invention;

FIG. 2 is a cross sectional view taken along II-II line shown in FIG. 1;

FIG. 3 is a partly cutaway exploded perspective view of the one-way rotational transfer mechanism shown in FIG. 1;

FIG. 4 is a longitudinal cross sectional view of a portion of the one-way rotational transfer mechanism shown in FIG. 1, illustrating magnetic circuits;

FIG. 5 is a view similar to that of FIG. 2, illustrating another embodiment of a circumferentially-uneven-width-space forming portion (non-circular cross section portion) having a different shape;

FIG. 6 is a cross sectional view of a portion of another embodiment of the circumferentially-uneven-width-space forming portion having a different shape;

FIG. 7 is a cross sectional view of another embodiment of the circumferentially-uneven-width-space forming portion having a different shape;

FIG. 8 is a longitudinal cross sectional view of a second embodiment of the one-way rotational transfer mechanism according to the present invention;

FIG. 9 is a cross sectional view taken along IX-IX line shown in FIG. 8;

FIG. 10 is an enlarged sectional view of a portion of the one-way rotational transfer mechanism shown in FIG. 9, illustrating the diameter of a ball;

FIG. 11 is a partly cutaway exploded perspective view of the one-way rotational transfer mechanism shown in FIG. 10;

FIG. 12 is a view similar to that of FIG. 9, illustrating another embodiment of the circumferentially-uneven-width-space forming portion (a non-circular cross section portion) having a different shape;

FIG. 13 is an enlarged sectional view of a portion of the one-way rotational transfer mechanism shown in FIG. 12, illustrating the diameter of a ball;

FIG. 14 is a longitudinal cross sectional view of another embodiment of the one-way rotational transfer mechanism according to the present invention which uses ball-incorporated hollow-cylindrical rollers instead of balls;

FIG. 15 is a perspective view of a ball-incorporated hollow-cylindrical roller shown in FIG. 14; and

FIG. 16 is a longitudinal cross sectional view of a modified embodiment of the one-way rotational transfer mechanism shown in FIG. 1 which uses cylindrical column rollers instead of balls.

### DESCRIPTION OF THE PREFERRED EMBODIMENTS

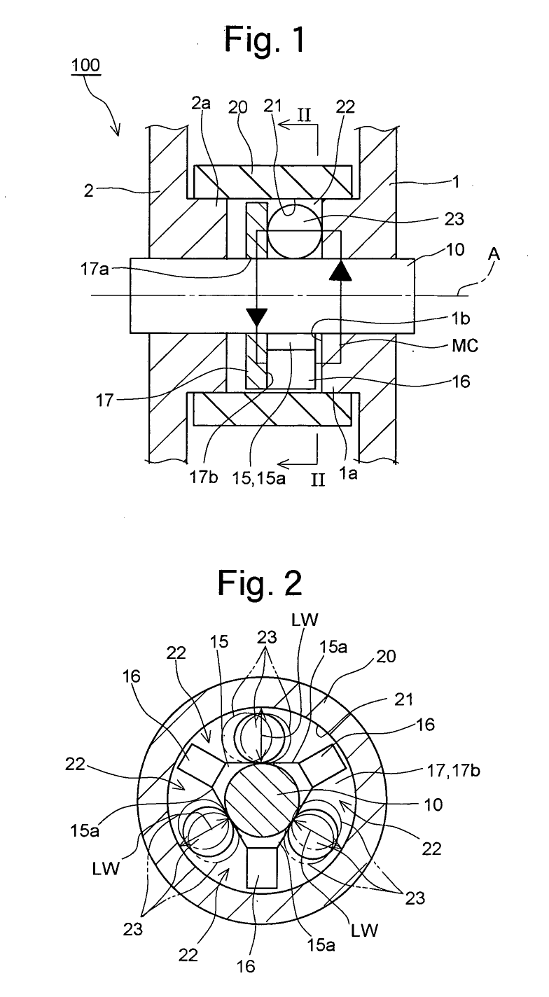

FIGS. 1 through 4 show a first embodiment of a one-way rotational transfer mechanism according to the present invention. The one-way rotational transfer mechanism 100 is provided with two parallel bearing plates: a first bearing plate (bearing member) 1 and a second bearing plate (bearing member) 2, which have bosses (bearings) 1a and 2a, respectively. Central holes of the bosses 1a and 2a are aligned with each other. The first bearing plate 1 is molded from a magnetic material such as metal (e.g., a ferrous metal except non-magnetic stainless steel). The one-way rotational transfer mechanism 100 is provided with a rotary input shaft 10 which is made of a non-magnetic material (e.g., stainless steel, brass or aluminum) and which is driven by a driving device such as a motor (not shown). The rotary input shaft 10 is fitted in the central holes of the bosses 1a and 2a so that the rotary input shaft 10 is freely rotatable about an axis A of the rotary input shaft 10 and freely movable in the direction of the axis A. The boss 1a is made of a magnetic material (e.g., a ferrous metal except non-magnetic stainless steel), and an end surface 1b of the boss 1a that is positioned at the left end thereof (the left end as viewed in FIG. 1; the horizontal direction of the one-way rotational transfer mechanism 100 is defined with reference to FIG. 1 in the following description) is formed as a first orthogonal surface which lies in a plane orthogonal to the axis A.

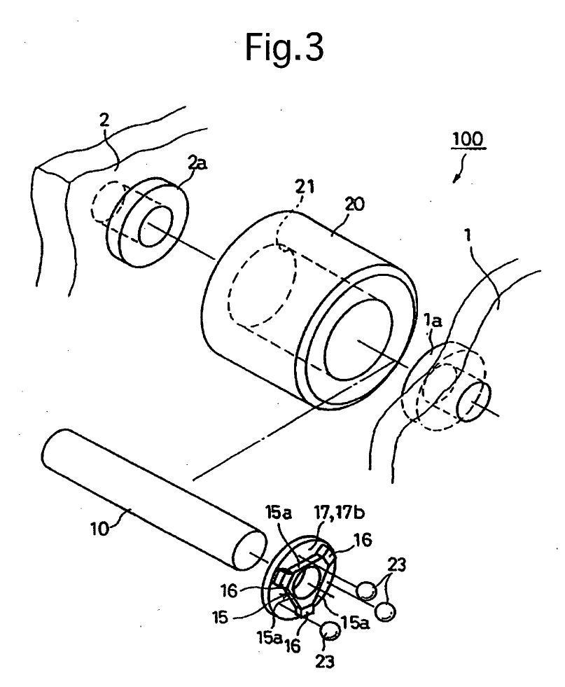

The rotary input shaft 10 is provided at a midpoint in the axial direction thereof with a triangular prism portion (non-circular cross section portion) 15 having the shape of a substantially regular triangle in cross section wherein each vertex thereof is chamfered. The triangular prism portion 15 is formed integral with the rotary input shaft 10 to serve as a circumferentially-uneven-width-space forming portion, and is made of a non-magnetic material (e.g., stainless steel, brass or aluminum). The triangular prism portion 15 and the rotary input shaft 10 are shown as separate elements in FIG. 3 for the purpose of showing the overall shape of the triangular prism portion 15. The outer peripheral surface of the triangular prism portion 15 is provided with three contact surfaces (roller member contact surfaces) 15a arranged at regular intervals (intervals of 120 degrees) about the axis A. Each contact surface 15a is a flat surface, and extends orthogonally to a radial direction of the rotary input shaft 10. Three permanent magnets (magnets) 16 are fixed to three chamfered vertex portions of the triangular prism portion 15, respectively, so that the north pole and the south pole of each permanent magnet 16 are positioned on the boss 1a side and the boss 2a side, respectively.

A annular retainer 17 made of a soft magnetic material is fitted on the rotary input shaft 10 to be fixed thereto with the rotary input shaft 10 being inserted in a central through-hole 17a of the annular retainer 17. The annular retainer 17 and the rotary input shaft 10 are shown as separate elements in FIG. 3 for the purpose of showing the overall shape of the annular retainer 17. A right end surface of the annular retainer 17 is formed as a second orthogonal surface 17b which lies in a plane orthogonal to the axis A and which is parallel to the first orthogonal surface 1b. The second orthogonal surface 17b is fixed to both a left end surface of the triangular prism portion 15 and a left end surface of each permanent magnet 16.

The one-way rotational transfer mechanism 100 is provided, on outer peripheral surfaces of the bosses 1a and 2a between the first and the second bearing plates 1 and 2, with a hollow-cylindrical rotary output shaft 20 which is freely rotatable about the axis A. The hollow-cylindrical rotary output shaft 20 is coaxially arranged around the rotary input shaft 10. The hollow-cylindrical rotary output shaft 20 has a simple hollow cylindrical shape, and has a cylindrical inner peripheral surface (cylindrical surface with its center on the axis A) 21. The cylindrical inner peripheral surface 21 defines three accommodation spaces (roller member accommodation spaces) 22 between the first orthogonal surface 1b and the second orthogonal surface 17b around the three contact surfaces 15a of the triangular prism portion 15. Each of the three accommodation spaces 22 serve as a circumferentially-uneven-width-space that has different radial widths at different circumferential positions. In the present embodiment shown in FIGS. 1 through 4, the number of accommodation spaces 22 formed by the circumferentially-uneven-width-space forming portion is three, and a ball (roller member) 23 is installed in each of the three accommodation spaces 22 because the triangular prism portion 15 that includes the three contact surfaces 15a serves as the circumferentially-uneven-width-space forming portion (non-circular cross section portion). The balls 23 have a diameter smaller than the maximum width (represented by double-headed arrows LW shown in FIG. 2) of each accommodation space 22 in a radial direction of the rotary input shaft 10. Namely, the three balls 23 are loosely inserted in the three accommodation spaces 22, respectively (each ball 23 can move in the associated accommodation space 22). Each ball 23 is a precision engineered hard ball made of a magnetic material such as metal (e.g., a ferrous metal except non-magnetic stainless steel). Balls of a conventional ball bearing can be used as the balls 23.

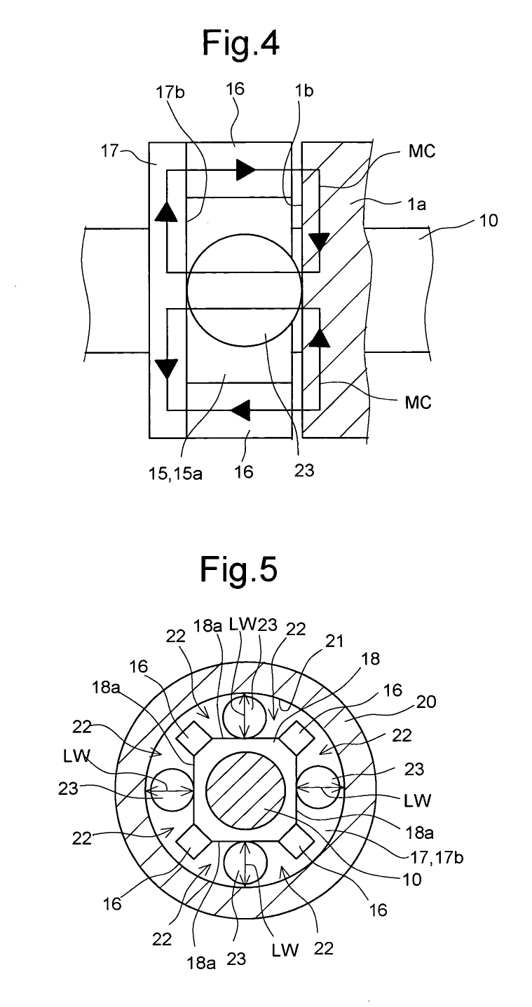

As shown in FIGS. 1 and 4, due to the magnetic forces generated by the three permanent magnets 16, magnetic circuits MC are formed from the permanent magnets 16, the boss 1a, the balls 23 and the annular retainer 17 to create a magnetic attractive force attracting the boss 1a and each ball 23 to each other, and another magnetic attractive force attracting each ball 23 and the annular retainer 17 to each other. Therefore, each ball 23 is in contact with the first orthogonal surface 1b at all times, the second orthogonal surface 17b is in contact with each ball 23 at all times and the rotary input shaft 10 is biased in a rightward direction as viewed in FIG. 1 relative to the first bearing plate 1.

Operations of the one-way rotational transfer mechanism 100 having the above described simple structure will be discussed hereinafter. Before the one-way rotational transfer mechanism 100 is operated, it is important for each ball 23 to be in intimate contact with the first orthogonal surface 1b while the second orthogonal surface 17b is in intimate contact with each ball 23 (so that each ball 23 is continuously sandwiched between the first orthogonal surface 1b and the second orthogonal surface 17b). If the rotary input shaft 10 is driven to rotate, the triangular prism portion 15 and the annular retainer 17 rotate together, and this rotation rotates each ball 23 that is in frictional contact with the second orthogonal surface 17b. Thereupon, each ball 23 moves from a neutral position thereof (indicated by a solid line in FIG. 2), in a rotational direction opposite to the rotational direction of the rotary input shaft 10 with respect to the second orthogonal surface 17b (see two-dot chain lines in FIG. 2), to move into one of wedge-shaped ends which are formed in the associated accommodation space 22 between the associated contact surface 15a of the triangular prism portion 15 and the cylindrical inner peripheral surface 21 of the hollow-cylindrical rotary output shaft 20. As a result, each ball 23 comes into firm contact with the cylindrical inner peripheral surface 21 to thereby transfer rotation of the rotary input shaft 10 to the hollow-cylindrical rotary output shaft 20, in the same rotational direction, via the three balls 23 and the cylindrical inner peripheral surface 21 of the hollow-cylindrical rotary output shaft 20. This action occurs regardless of the rotational direction of the rotary input shaft 10. Namely, rotation of the rotary input shaft 10 in either rotational direction can be transferred to the hollow-cylindrical rotary output shaft 20.

On the other hand, if the hollow-cylindrical rotary output shaft 20 is driven to rotate, each ball 23 merely rotates in the associated accommodation space 22 because the ball 23 is merely in point contact with the cylindrical inner peripheral surface 21 of the hollow-cylindrical rotary output shaft 20 even if the ball 23 is in contact with the cylindrical inner peripheral surface 21. Therefore, no rotation of the hollow-cylindrical rotary output shaft 20 is transferred to the rotary input shaft 10 even if a rotation is applied to the hollow-cylindrical rotary output shaft 20. Namely, when the rotary input shaft 10 is driven to rotate, each ball 23 is engaged with one of the wedge-shaped ends that are formed between the associated contact surface 15a of the triangular prism portion 15 and the cylindrical inner peripheral surface 21 because the rotation of the rotary input shaft 10 is transferred to each ball 23 via the second orthogonal surface 17b. Consequently, the rotation of the rotary input shaft 10 is transferred to the hollow-cylindrical rotary output shaft 20. However, when the hollow-cylindrical rotary output shaft 20 is driven to rotate, very little force or substantially no force is generated, i.e., sufficient force for causing each ball 23 to be engaged with one of the wedge-shaped ends is not generated, because the rotation of the hollow-cylindrical rotary output shaft 20 is transferred to each ball 23 via the cylindrical inner peripheral surface 21. As a consequence, the rotation of the hollow-cylindrical rotary output shaft 20 is not transferred to the rotary input shaft 10.

According to the above described embodiment of the one-way rotational transfer mechanism, since the balls 23 are sandwiched between the second orthogonal surface 17b of the annular retainer 17 and the first orthogonal surface 1b of the first bearing plate 1 with the use of the magnetic force generated by the magnetic circuits MC, no factor which gives rise to a loss of torque of the rotary input shaft 10 (i.e., frictional force which occurs between a conventional spring device and the annular retainer 17) exists. Accordingly, an improvement in efficiency of transmitting a torque from the rotary input shaft 10 to the hollow-cylindrical rotary output shaft 20 can be achieved.

In the above described one-way rotational transfer mechanism 100, if the hollow-cylindrical rotary output shaft 20 is firmly held so as not to rotate relative to the first and second bearing plates 1 and 2, each ball 23 merely rotates in the associated accommodation space 22 while sliding on the second orthogonal surface 17b of the annular retainer 17 and the first orthogonal surface 1b of the boss 1a even when the rotary input shaft 10 is driven to rotate, unless either the triangular prism portion 15 or the hollow-cylindrical rotary output shaft 20 is broken. This means that the one-way rotational transfer mechanisms 100 can also serve as a torque limiter. Torque which can be transferred from the rotary input shaft 10 to the hollow-cylindrical rotary output shaft 20 can be determined by the following factors: the number of the accommodation spaces 22 (the number of the balls 23), internal angles of the wedge-shaped ends that are formed between the associated contact surface 15a of the triangular prism portion 15 and the cylindrical inner peripheral surface 21, the magnetic force generated by the magnetic circuits MC, the surface friction of the first orthogonal surface 1b of the boss 1a (i.e., the friction between the first orthogonal surface 1b and each ball 23), and the surface friction of the second orthogonal surface 17b of the annular retainer 17 (i.e., the friction between the second orthogonal surface 17b and each ball 23).

The simplest way to change the number of the accommodation spaces 22 (the number of the balls 23) is to provide a polygonal prism portion on the rotary input shaft 10 instead of the triangular prism portion 15. FIG. 5 shows another embodiment of the circumferentially-uneven-width-space forming portion. In this embodiment, the circumferentially-uneven-width-space forming portion (non-circular cross section portion) of the rotary input shaft 10 that is made of a non-magnetic material (e.g., stainless steel, brass or aluminum) is formed as a substantially quadratic prism portion 18 integrally with the rotary input shaft 10. The quadratic prism portion 18 has the shape of a substantially square in cross section wherein each corner thereof is chamfered. The quadratic prism portion 18 is provided on the outer peripheral surface thereof with four contact surfaces (roller member contact surfaces) 18a arranged at regular intervals about the axis A. Each contact surface 18a is a flat surface, and extends orthogonally to a radial direction of the rotary input shaft 10. Four permanent magnets 16 are fixed to four chamfered corners of the quadratic prism portion 18, respectively, so that the north pole and the south pole of each permanent magnet 16 are positioned on the boss 1a side and the boss 2a side, respectively. The cylindrical inner peripheral surface 21 of the hollow-cylindrical rotary output shaft 20 defines four accommodation spaces (roller member accommodation spaces) 22 between the first orthogonal surface 1b and the second orthogonal surface 17b around the four contact surfaces 18a of the quadratic prism portion 18. Each of the four accommodation spaces 22 serves as a circumferentially-uneven-width-space that has different radial widths at different circumferential positions. The balls 23 have a diameter smaller than the maximum width (represented by double-headed arrows LW shown in FIG. 5) of each accommodation space 22 in a radial direction of the rotary input shaft 10. Namely, the four balls 23 are loosely inserted in the four accommodation spaces 22, respectively (each ball 23 can move in the associated accommodation space 22). Similar to the embodiment shown in FIGS. 1 through 4, magnetic circuits MC are formed from the permanent magnets 16, the boss 1a, the balls 23 and the annular retainer 17.

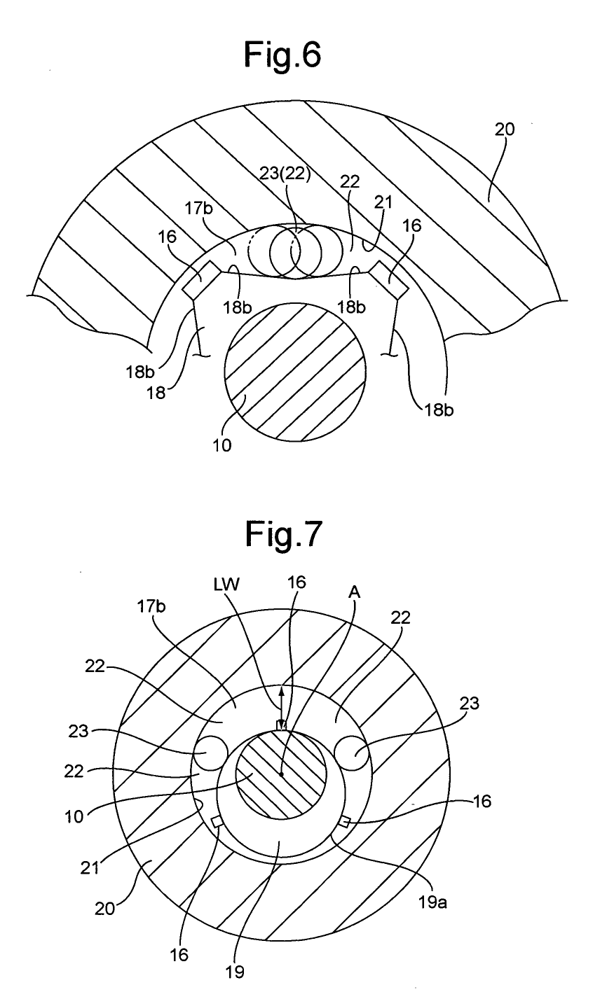

Theoretically, the number of the accommodation spaces 22 (the number of the balls 23) which is formed by the circumferentially-uneven-width-space forming portion (non-circular cross section portion)can be one if balance does not have to be considered (if balance can be achieved). Although each contact surface 15a and 18a is even and extends orthogonal to a radial direction of the rotary input shaft 10 in each of the embodiment shown in FIGS. 1 through 4 and the embodiment shown in FIG. 5, each contact surface of the polygonal prism portion can be modified as an uneven surface as shown in another embodiment of the circumferentially-uneven-width-space forming portion shown in FIG. 6. In this embodiment shown in FIG. 6, each contact surface of the substantially quadratic prism portion 18 that is in contact with the associated ball 23 is formed as at least one pair of inclined surfaces 18b which are symmetrical with respect to a line extending in a radial direction of the rotary input shaft 10; four pairs of inclined surfaces 18b are formed on the quadratic prism portion 18. Similar to the embodiment shown in FIG. 5, the four balls 23 are loosely inserted in the four accommodation spaces 22, respectively, in the embodiment shown in FIG. 6. The internal angles of the aforementioned wedge-shaped ends can be easily determined and adjusted by changing the angle of inclination of each pair of inclined surfaces 18b. If the pair of inclined surfaces 18b are formed asymmetrical with respect to a line extending in a radial direction of the rotary input shaft 10, the torque which is transferred from the rotary input shaft 10 to the hollow-cylindrical rotary output shaft 20 when the rotary input shaft 10 is driven to rotate in a forward rotational direction can be set different from when the rotary input shaft 10 is driven to rotate in a reverse rotational direction.

An eccentric cylindrical surface eccentric from the axis of the rotary input shaft 10 can serve as the circumferentially-uneven-width-space forming portion. FIG. 7 shows another embodiment of the circumferentially-uneven-width-space forming portion. In this embodiment of the circumferentially-uneven-width-space forming portion, a cylindrical column portion 19 having an eccentric cylindrical surface 19a which is eccentric from the axis A of the rotary input shaft 10 is integrally formed with the rotary input shaft 10, instead of the triangular prism portion 15 shown in FIGS. 1 through 4, to serve as a circumferentially-uneven-width-space forming portion. The cylindrical column portion 19 is made of a non-magnetic material (e.g., stainless steel, brass or aluminum). Three permanent magnets (magnets) 16 are fixed to the outer peripheral surface of the cylindrical column portion 19 at three different positions thereon in a circumferential direction, respectively, so that the north pole and the south pole of each permanent magnet 16 are positioned on the boss 1a side and the boss 2a side, respectively. The cylindrical inner peripheral surface 21 of the hollow-cylindrical rotary output shaft 20 defines two accommodation spaces (roller member accommodation spaces) 22 between the first orthogonal surface 1b and the second orthogonal surface 17b around the eccentric cylindrical surface 19a. Each of the two accommodation spaces 22 serves as a circumferentially-uneven-width-space which is shaped to be bilaterally symmetrical as viewed in FIG. 7. Two balls 23 are inserted in the accommodation spaces 22, respectively. Similar to each of the above described embodiments, the balls 23 have a diameter smaller than the maximum width (represented by a double-headed arrow LW shown in FIG. 7) of the accommodation space 22 in a radial direction of the rotary input shaft 10 so that each ball 23 can move in the accommodation space 22. Namely, the two balls 23 are loosely inserted in the accommodation space 22. The embodiment shown in FIG. 7 is effective on condition that one ball 23 stably remains in one accommodation space 22 and the other ball 23 stably remains in the other accommodation space 22, respectively, i.e., so long as both the two balls 23 do not move to either one of the accommodation spaces 22.

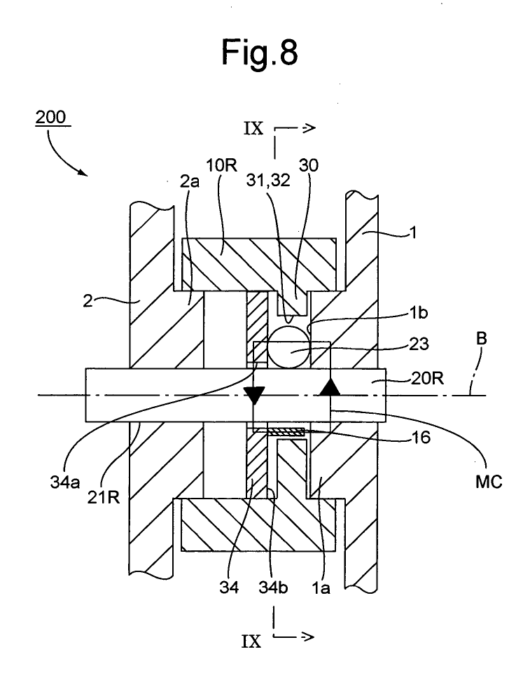

FIGS. 8 through 11 show the second embodiment of the one-way rotational transfer mechanism according to the present invention. In this embodiment of the one-way rotational transfer mechanism 200, elements and parts similar to those in the first embodiment of the one-way rotational transfer mechanism are designated by the same reference numerals. In the one-way rotational transfer mechanism 200, the rotary input shaft is positioned around the rotary output shaft, whereas in the first embodiment of the one-way rotational transfer mechanism 100 the rotary output shaft is positioned around the rotary input shaft. Namely, the one-way rotational transfer mechanism 200 is provided with a rotary output shaft 20R which is fitted in the central holes of the bosses 1a and 2a so that the rotary output shaft 20R is freely rotatable on an axis B of the rotary output shaft 20R, while the one-way rotational transfer mechanism 200 is provided, on outer peripheral surfaces of the bosses 1a and 2a between the first and the second bearing plates 1 and 2, with a hollow-cylindrical rotary input shaft 10R which is positioned concentrically to the rotary output shaft 20R. The hollow-cylindrical rotary input shaft 10R is made of a non-magnetic material (e.g., stainless steel, brass or aluminum). The hollow-cylindrical rotary input shaft 10R is freely rotatable about the axis B of the rotary output shaft 20R relative to the bosses 1a and 2a, and freely slidable within the bosses 1a and 2a in a direction of the axis B. The hollow-cylindrical rotary input shaft 10R is provided on an inner peripheral surface thereof with an integrally-molded inner flange 30 made of a non-magnetic material (e.g., stainless steel, brass or aluminum), and is further provided radially inside of the inner flange 30 with a triangular-prism-shaped space 31 serving as a circumferentially-uneven-width-space forming portion (non-circular cross section portion). The inner flange 30 is provided on the inner peripheral surface thereof with three contact surfaces (roller member contact surfaces) 32 arranged at regular intervals (intervals of 120 degrees) about the axis B. Each contact surface 32 is a flat surface, and extends orthogonally to a radial direction of the hollow-cylindrical rotary input shaft 10R. Additionally, the three contact surfaces 32 that form the triangular-prism-shaped space 31 respectively correspond to the three sides of a regular triangle with its center on the axis B as viewed in the direction of the axis B.

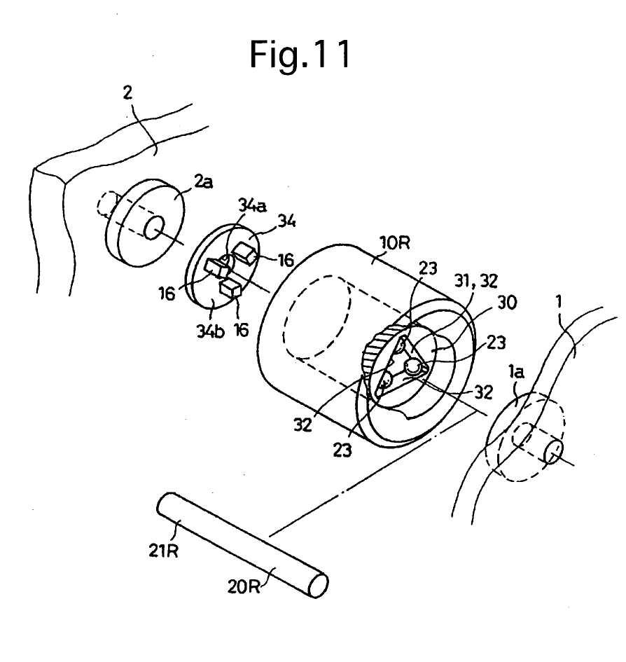

A annular retainer 34 made of a soft magnetic material, which has an outer diameter the same as the inner diameter of the hollow-cylindrical rotary input shaft 10R, is firmly fitted in the hollow-cylindrical rotary input shaft 10R to be fixed thereto on the left side of the inner flange 30 (the horizontal direction of the one-way rotational transfer mechanism 200 is defined with reference to FIG. 8 in the second embodiment of the one-way rotational transfer mechanism). The annular retainer 34 and the hollow-cylindrical rotary input shaft 10R are shown as separate elements in FIG. 11 for the purpose of showing the overall shape of the annular retainer 34. The rotary output shaft 20R is loosely fitted in a central through-hole 34a bored in the annular retainer 34 at the center thereof, and a right end surface of the annular retainer 34 is formed as a second orthogonal surface 34b which lies in a plane orthogonal to the axis B and which is parallel to the first orthogonal surface 1b. The three contact surfaces 32 of the inner flange 31 defines three accommodation spaces (roller member accommodation spaces) 22 between the second orthogonal surface 34b and the first orthogonal surface 1b (orthogonal to the axis B) around an outer peripheral surface 21R, which is centered on the axis B, of the rotary output shaft 20R. Each of the three accommodation spaces 22 serves as a circumferentially-uneven-width-space that has different radial widths at different circumferential positions.

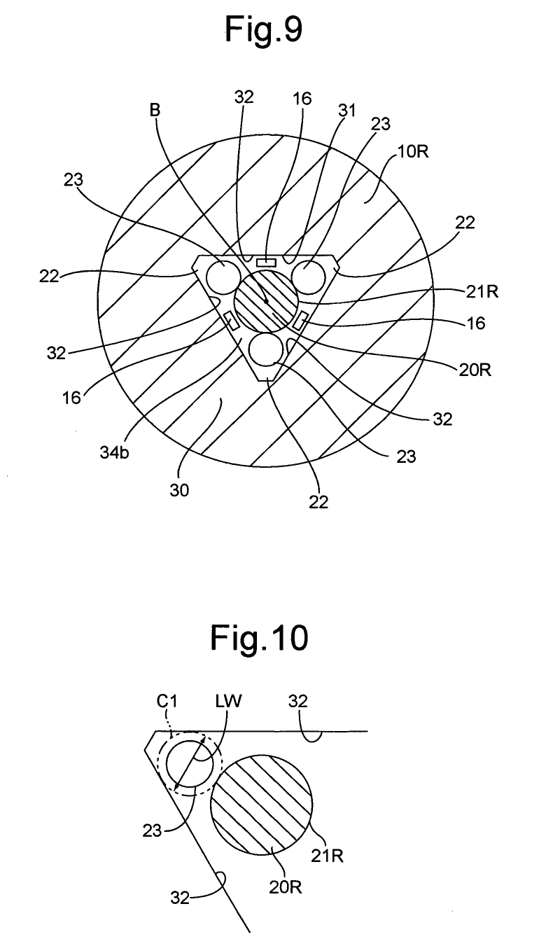

Three permanent magnets 16 are fixed to the second orthogonal surface 34b at three different points thereon around the axis B, respectively. As shown in FIG. 9, the permanent magnets 16 are fixed to the second orthogonal surface 34b at circumferentially regular intervals (intervals of 120 degrees) about the axis B as viewed in the direction of the axis B. Similar to each of the above described embodiments of the circumferentially-uneven-width-space forming portions, the north pole and the south pole of each permanent magnet 16 are positioned on the boss 1a side and the boss 2a side, respectively. Three balls 23 are inserted in the three accommodation spaces 22, respectively, while the three balls 23 stay away from the three permanent magnets 16. In this embodiment, if it is assumed that in each accommodation space 22 the diameter C1 of a circle inscribed in two adjacent contact surfaces 32 and the outer peripheral surface 21R of the rotary output shaft 20R is LW, as shown in FIG. 10, the balls 23 have a diameter smaller than the diameter LW so that each ball 23 can move in the associated accommodation space 22. Namely, the three balls 23 are loosely inserted in the three accommodation spaces 22, respectively.

Due to the magnetic forces generated by the three permanent magnets 16, magnetic circuits MC are formed from the permanent magnets 16, the boss 1a, the balls 23 and the annular retainer 34 to create a magnetic attractive force attracting the boss 1a and each ball 23 to each other, and another magnetic attractive force attracting each ball 23 and the annular retainer 34 to each other. Therefore, each ball 23 is in contact with the first orthogonal surface 1b at all times, the second orthogonal surface 34b is in contact with each ball 23 at all times and the hollow-cylindrical rotary input shaft 10R is biased to move rightward as viewed in FIG. 8 relative to the first bearing plate 1.

According to the second embodiment of the one-way rotational transfer mechanism 200 shown in FIGS. 8 through 11, an effect similar to that obtained in the first embodiment of the one-way rotational transfer mechanism 100 is obtained. Namely, when the hollow-cylindrical rotary input shaft 10R is driven to rotate, each ball 23 rotates by rotation of the second orthogonal surface 34b to move in a direction so as to wedge into one of wedge-shaped ends which are formed in the associated accommodation space 22 between the associated two adjacent contact surfaces 32 of the inner flange 30 and the outer peripheral surface 21R of the rotary output shaft 20R. Consequently, the rotation of the hollow-cylindrical rotary input shaft 10R is transferred to the rotary output shaft 20R. However, if a rotation is applied to the rotary output shaft 20R, each ball 23 merely rotates in the associated accommodation space 22 by the rotation of the outer peripheral surface 21R of the rotary output shaft 20R, and accordingly, the rotation of the rotary output shaft 20R is not transferred to the hollow-cylindrical rotary input shaft 10R.

According to the above described second embodiment of the one-way rotational transfer mechanism, since the balls 23 are sandwiched between the annular retainer 34 and the first orthogonal surface 1b with the use of the magnetic force generated by the magnetic circuits MC in a manner similar to that of the first embodiment of the one-way rotational transfer mechanism 100, no factor which gives rise to a loss of torque of the hollow-cylindrical rotary input shaft 10R (i.e., frictional force which occurs between a conventional spring device and the annular retainer 34) exists. Accordingly, an improvement in efficiency of transmitting a torque from the hollow-cylindrical rotary input shaft 10R to the rotary output shaft 20R can be been achieved.

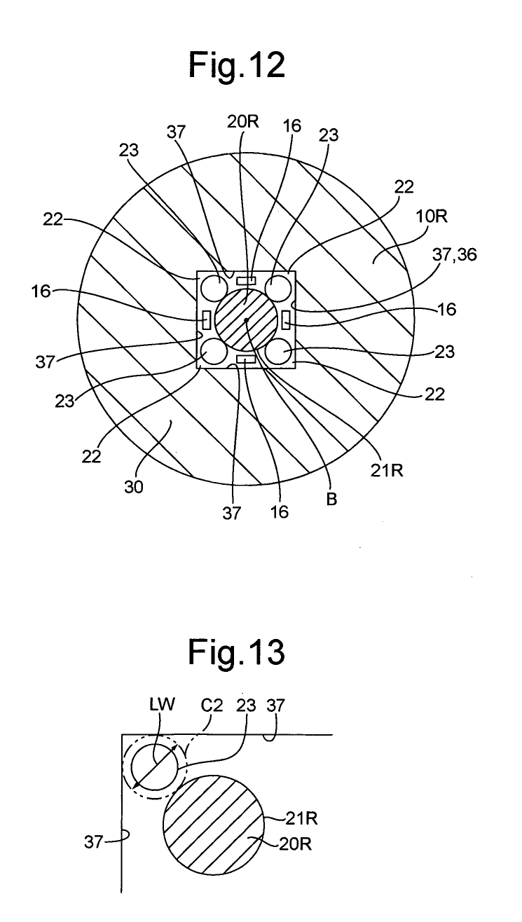

FIG. 12 shows another embodiment of the circumferentially-uneven-width-space forming portion of the second embodiment of the one-way rotational transfer mechanism 200. This embodiment of the circumferentially-uneven-width-space forming portion is provided at a center of the inner flange 30 with a square-prism-shaped space 36 (the inner flange 30 serves as the circumferentially-uneven-width-space forming portion). Namely, the central through-hole of the inner flange 30 has a square shape in cross section as shown in FIG. 12. The inner flange 30 is provided on the inner peripheral surface thereof with four contact surfaces (roller member contact surfaces) 37 arranged at regular intervals (intervals of 90 degrees) about the axis B. Each contact surface 37 is a flat surface, and extends orthogonally to a radial direction of the rotary output shaft 20R. In this embodiment, if it is assumed that in each accommodation space 22 the diameter C2 of a circle inscribed in two adjacent contact surfaces 37 and the outer peripheral surface 21R of the rotary output shaft 20R is LW as shown in FIG. 13, the balls 23 have a diameter smaller than the diameter LW so that each ball 23 can move in the associated accommodation space 22. Namely, the four balls 23 are loosely inserted in the four accommodation spaces 22, respectively. According to this embodiment shown in FIG. 12, the internal angle of each of the wedge-shaped ends that are formed in each accommodation space 22 by the contact surfaces 37 and the rotary output shaft 20R is greater than that of the embodiment shown in FIGS. 8 through 11. Accordingly, the embodiment shown in FIG. 12 is effectively used, especially when the torque which is transferred from the hollow-cylindrical rotary input shaft 10R to the rotary output shaft 20R is small. Nevertheless, the maximum transferable torque can be increased by using smaller balls, which makes it possible to decrease the internal angles of the wedge-shaped ends. This embodiment shown in FIG. 12 can be modified to be provided with an eccentric cylindrical surface corresponding to the eccentric cylindrical surface 19a shown in FIG. 7.

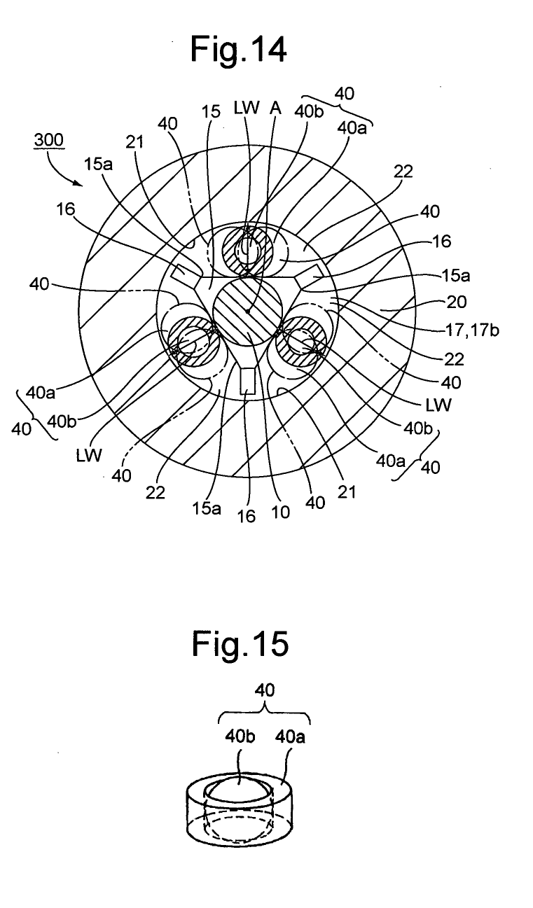

FIGS. 14 and 15 show another embodiment of the one-way rotational transfer mechanism 300 according to the present invention. This embodiment of the one-way rotational transfer mechanism 300 is substantially the same as the first embodiment of the one-way rotational transfer mechanism 100 shown in FIGS. 1 through 4 except that the one-way rotational transfer mechanism 300 uses ball-incorporated hollow-cylindrical rollers (roller members) 40 instead of the balls 23. As shown in FIG. 15, the ball-incorporated hollow-cylindrical rollers 40 are provided with a hollow cylinder 40a and a ball 40b which is loosely fitted in the hollow cylinder 40a. The hollow cylinder 40a is made of a non-magnetic material (e.g., stainless steel, brass or aluminum), while the ball 40b is made of a magnetic material (e.g., a ferrous metal except non-magnetic stainless steel). Similar to the balls 23 of the one-way rotational transfer mechanism 100, balls of a conventional ball bearing can be used as the balls 40b. The axial lengths of the hollow cylinders 40a are slightly smaller than the diameters of the balls 40b. As shown in FIG. 14, the three ball-incorporated hollow-cylindrical rollers 40 are respectively installed in the three accommodation spaces 22 so that the axis of each ring 40a extends substantially parallel to the respective axes of the rotary input shaft 10 and the hollow-cylindrical rotary output shaft 20 and so that each ball-incorporated hollow-cylindrical roller 40 can move in the associated accommodation space 22. In addition, the hollow cylinders 40a have an outer diameter smaller than the maximum width (represented by double-headed arrows LW shown in FIG. 14) of each accommodation space 22 in a radial direction of the rotary input shaft 10 so that each hollow cylinder 40a can move in the associated accommodation space 22. Accordingly, the outer peripheral surfaces of the hollow cylinders 40a can contact the contact surfaces 15a of the triangular prism portion 15 and the cylindrical inner peripheral surface 21 of the rotary output shaft 20. The balls 40b are held between the second orthogonal surface 17b of the annular retainer 17 and the first orthogonal end surface 1b of the boss 1a by the magnetic force generated by the magnetic circuits MC, which are formed from the permanent magnets 16, the boss 1a, the balls 40b and the annular retainer 17, whereas the rings 40a are not held between the second orthogonal surface 17b of the annular retainer 17 and the first orthogonal end surface 1b of the boss 1a because the axial lengths of the hollow cylinders 40a are slightly smaller than the diameters of the balls 40b. According to the embodiment of the one-way rotational transfer mechanism 300, an effect similar to the effect obtained in the first embodiment of the one-way rotational transfer mechanism 100 is obtained. In addition, a greater torque can be transferred from the rotary input shaft 10 to the hollow-cylindrical rotary output shaft 20 as compared with the first embodiment of the one-way rotational transfer mechanism 100 because the ring 40a of each ball-incorporated hollow-cylindrical roller 40 can come into surface contact with each of the associated contact surface 15a of the triangular prism portion 15 and the cylindrical inner peripheral surface 21 of the hollow-cylindrical rotary output shaft 20.

The balls 23 can be respectively replaced by the ball-incorporated hollow-cylindrical rollers 40 in each embodiment shown in FIGS. 5 through 13 to obtain a similar effect.

Additionally, each permanent magnet 16 can be replaced by an electromagnet in each illustrated embodiment to obtain a similar effect.

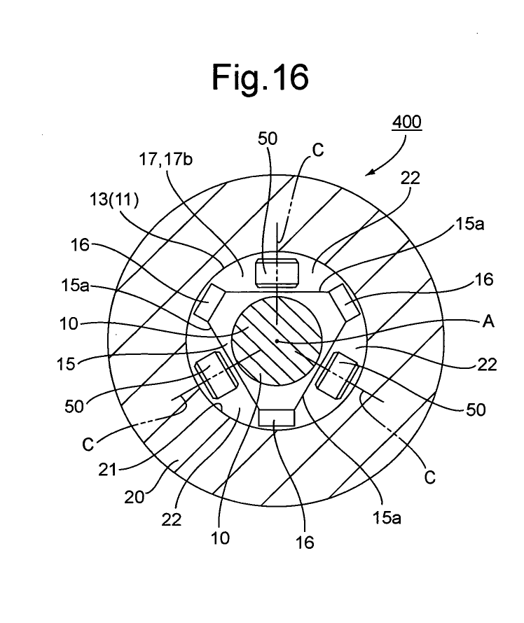

FIG. 16 shows another embodiment of the one-way rotational transfer mechanism according to the present invention. This embodiment of the one-way rotational transfer mechanism 400 is substantially the same as the first embodiment of the one-way rotational transfer mechanism 100 except that the one-way rotational transfer mechanism 400 uses cylindrical column rollers (roller members) 50 instead of the balls 23. The cylindrical column rollers 50 are made of a magnetic material such as metal (e.g., a ferrous metal except non-magnetic stainless steel). The annular edge of each axial end of each cylindrical column roller 50 is beveled as shown in FIG. 16. The cylindrical column rollers 50 are respectively installed in the three accommodation spaces 22 so that the axis of each cylindrical column roller 50 extends in a substantially radial direction of the rotary input shaft 10 as shown in FIG. 16 and so that each cylindrical column roller 50 can move in the associated accommodation space 22. The cylindrical column rollers 50 are held between the second orthogonal surface 17b of the annular retainer 17 and the first orthogonal end surface 1b of the boss 1a by the magnetic force generated by the magnetic circuits MC, which are formed from the permanent magnets 16, the boss 1a, the cylindrical column rollers 50 and the annular retainer 17. According to this embodiment of the one-way rotational transfer mechanism 400, an effect similar to the effect obtained in the first embodiment of the one-way rotational transfer mechanism 100 is obtained.

In each embodiment shown in FIGS. 5 through 13, the balls 23 can be respectively replaced by the cylindrical column rollers 50 shown in FIG. 16 to obtain a similar effect.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A one-way rotational transfer mechanism comprising:
a rotary input shaft and a hollow-cylindrical rotary output shaft which are coaxially arranged about a common axis, said rotary input shaft being movable along said common axis and being rotatable about said common axis;
a bearing which supports said rotary input shaft and said hollow-cylindrical rotary output shaft and on which a first orthogonal surface is formed to lie in a plane orthogonal to said axis;
a circumferentially-uneven-width-space forming portion integrally formed on said rotary input shaft to form at least one accommodation space between said circumferentially-uneven-width-space forming portion and a cylindrical inner peripheral surface of said hollow-cylindrical rotary output shaft, said accommodation space having different radial widths at different circumferential positions about said axis;
a retainer which moves with said rotary input shaft and on which a second orthogonal surface is formed to face said first orthogonal surface and is parallel to said first orthogonal surface;
at least one roller member installed in said accommodation space and held between said first orthogonal surface and said second orthogonal surface, each of said bearing, said retainer and said roller member being made of a magnetic material; and
at least one magnetic circuit which creates a magnetic attractive force attracting said first orthogonal surface and said roller member to each other, and attracting said roller member and said second orthogonal surface to each other,
wherein said circumferentially-uneven-width-space forming portion is shaped so that a rotation of said rotary input shaft is transferred to said hollow-cylindrical rotary output shaft via said roller member to which said rotation is applied via said first orthogonal surface and said second orthogonal surface when said rotary input shaft is rotated.

2. The one-way rotational transfer mechanism according to claim 1, wherein said roller member comprises a ball made of said magnetic material.

3. The one-way rotational transfer mechanism according to claim 1, wherein said roller member comprises.:
a ball made of said magnetic material; and
a hollow cylinder made of a non-magnetic material in which said ball is loosely fitted,
wherein an axial length of said hollow cylinder is smaller than a diameter of said ball; and
wherein said hollow cylinder is positioned in associated said accommodation space so that an axis of said hollow cylinder extends substantially parallel to each of an axis of said rotary input shaft and an axis of said hollow-cylindrical rotary output shaft.

4. The one-way rotational transfer mechanism according to claim 1, wherein said roller member comprises a cylindrical column roller which is positioned in associated said accommodation space so that an axis of said cylindrical column roller extends substantially in a radial direction of said rotary input shaft.

5. The one-way rotational transfer mechanism according to claim 1, wherein said circumferentially-uneven-width-space forming portion comprises a non-circular cross section portion which includes at least one surface orthogonal to a radial direction of said rotary input shaft.

6. The one-way rotational transfer mechanism according to claim 5, wherein said circumferentially-uneven-width-space forming portion having said non-circular cross section is in the shape of a polygon.

7. The one-way rotational transfer mechanism according to claim 1, wherein said circumferentially-uneven-width-space forming portion comprises a non-circular cross section portion which has at least one pair of inclined surfaces which are symmetrical with respect to a line extending in a radial direction of said rotary input shaft.

8. The one-way rotational transfer mechanism according to claim 1, wherein said circumferentially-uneven-width-space forming portion comprises an eccentric cylindrical surface which is eccentric from said axis of said rotary input shaft.

9. The one-way rotational transfer mechanism according to claim 1, wherein said magnetic circuit is formed with magnets positioned between said first orthogonal surface and said second orthogonal surface.

10. The one-way rotational transfer mechanism according to claim 9, wherein said magnet comprises a permanent magnet.

11. A one-way rotational transfer mechanism comprising:
a hollow-cylindrical rotary input shaft and a rotary output shaft which are coaxially arranged about a common axis, said hollow-cylindrical rotary input shaft being movable along said common axis and being rotatable about said common axis;
a bearing which supports said hollow-cylindrical rotary input shaft and said rotary output shaft and on which a first orthogonal surface is formed to lie in a plane orthogonal to said axis;
a circumferentially-uneven-width-space forming portion integrally formed on an inner peripheral surface of said hollow-cylindrical rotary input shaft to form at least one accommodation space between said circumferentially-uneven-width-space forming portion and a cylindrical outer peripheral surface of said rotary output shaft, said accommodation space having different radial widths at different circumferential positions about said axis;
a retainer which moves with said hollow-cylindrical rotary input shaft and on which a second orthogonal surface is formed to face said first orthogonal surface and is parallel to said first orthogonal surface; and
at least one roller member installed in said accommodation space and held between said first orthogonal surface and said second orthogonal surface, each of said bearing, said retainer and said roller member being made of a magnetic material; and
at least one magnetic circuit which creates a magnetic attractive force attracting said first orthogonal surface and said roller member to each other, and attracting said roller member and said second orthogonal surface to attract each other,
wherein said circumferentially-uneven-width-space forming portion is shaped so that a rotation of said hollow-cylindrical rotary input shaft is transferred to said rotary output shaft via said roller member to which said rotation is applied via said first orthogonal surface and said second orthogonal surface when said hollow-cylindrical rotary input shaft is rotated.

12. The one-way rotational transfer mechanism according to claim 11, wherein said roller member comprises a ball made of said magnetic material.

13. The one-way rotational transfer mechanism according to claim 11, wherein said roller member comprises:
a ball made of said magnetic material; and
a hollow cylinder made of a non-magnetic material in which said ball is loosely fitted,
wherein an axial length of said hollow cylinder is smaller than a diameter of said ball; and
wherein said hollow cylinder is positioned in associated said accommodation space so that an axis of said hollow cylinder extends substantially parallel to each of an axis of said hollow-cylindrical rotary input shaft and an axis of said rotary output shaft.

14. The one-way rotational transfer mechanism according to claim 11, wherein said roller member comprises a cylindrical column roller which is positioned in associated said accommodation space so that an axis of said cylindrical column roller extends substantially in a radial direction of said rotary input shaft.

15. The one-way rotational transfer mechanism according to claim 11, wherein said circumferentially-uneven-width-space forming portion comprises a non-circular cross section portion which includes at least one surface orthogonal to a radial direction of said hollow-cylindrical rotary input shaft.

16. The one-way rotational transfer mechanism according to claim 15, wherein said circumferentially-uneven-width-space forming portion having said non-circular cross section is in the shape of a polygon.

17. The one-way rotational transfer mechanism according to claim 11, wherein said circumferentially-uneven-width-space forming portion comprises a non-circular cross section portion which has at least one pair of inclined surfaces which are symmetrical with respect to a line extending in a radial direction of said hollow-cylindrical rotary input shaft.

18. The one-way rotational transfer mechanism according to claim 11, wherein said circumferentially-uneven-width-space forming portion comprises an eccentric cylindrical surface which is eccentric from said axis of said hollow-cylindrical rotary input shaft.

19. The one-way rotational transfer mechanism according to claim 11, wherein said magnetic circuit is formed with magnets positioned between said first orthogonal surface and said second orthogonal surface.

20. The one-way rotational transfer mechanism according to claim 19, wherein said magnet comprises a permanent magnet.
